(19) United States
(12) Patent Application Publication
(10) Pub. No.: US 2010/0026129 A1
(43) Pub. Date: Feb. 4, 2010

(54) METHOD OF GENERATING ELECTRICAL POTENTIAL FROM A STATIONARY MAGNET AND A STATIONARY CONDUCTOR

(76) Inventor: Richard K. Black, JR., Deerfield Beach, FL (US)

Correspondence Address: DEFILLO & ASSOCIATES, INC., P.O. Box 14104, Clearwater, FL, 33766, US

(21) Appl. No.: 12/248,960

(22) Filed: Oct. 10, 2008

Related U.S. Application Data
(60) Provisional application No. 61/137,548, filed on Aug. 1, 2008.

(51) Int. Cl. H02K 21/38

(52) U.S. Cl. 310/168

(57) ABSTRACT

The present invention relates to a method and device of generating electrical potential by placing a magnetic shielding and/or deflecting material between a stationary magnet and a stationary conductor, then mechanically altering the position of the magnetic shielding and/or deflecting material so as to alternately shield or expose the stationary conductor to the lines of flux radiating from the stationary magnet and across the stationary conductor. This continuous expansion and contraction of the magnetic lines of flux across the stationary conductor generates an electric potential across the output of the stationary conductor.

### REFERENCE TO RELATED APPLICATIONS

This application is a non-provisional of Provisional Application No. 61/137,548 filed Aug. 1, 2008, the contents of which are incorporated herein by reference.

### FIELD OF THE INVENTION

The present invention relates to a method and device that generates electrical potential.

### BACKGROUND OF THE INVENTION

Generating electrical energy mechanically has always depended on the three basic principles discovered by Michael Faraday in the early 1830's. First, there must be a conductor in which to induce voltage; second, a magnetic field must be close enough to the conductor for the magnetic lines of force to cut across the conductor; and third, either the conductor or the magnetic field must be moving.

Faraday discovered that an electric potential could be established between the ends of a conductor in the following ways:

By a conductor moving or cutting across a stationary magnetic field; or

By a moving magnetic field cutting or cutting across a stationary conductor.

The some of the prior art references show electromagnetic power generator systems wherein one or more magnets are moved relative to a conductor (e.g., one or more coils of wire) or vice versa to induce electromotive forces (i.e., a flow of electrons) therein. More specifically, the magnets were moved relative to a stationary conductor so that the magnetic lines of flux radiating from the magnets intersect the conductor at right angles and induce the electromotive forces. In another case, the conductors were moved relative to the stationary magnet to induce the electromotive forces.

According to Faraday's law, the Electro Motive Force EMF (i.e., voltage) developed in the coil is equal to the number of turns of the wire in the coil multiplied by the change in the magnetic flux that each loop is exposed to. Therefore, one of the goals of the EMF power generator design is to maximize the power output of the generator by maximizing any or all of the terms of Faraday's law individually or in combination, subject to physical and material limitations.

When a permanent magnet moves towards the coil, an electrical field is generated on the surface of the coil's wire, and this field moves along the coil's turns, generating a magnetic field inside and outside the coil; interaction of this magnetic field with the permanent magnet's field repulses the magnet, while, when the magnet moves away from the coil, magnetic field generated in the coil pulls the magnet back. Additionally, the electrical current flowing in the coil also produces an electromagnetic field that interacts with the magnets and slows them down.

As the result, all the electric power generators that use the Faraday principles to generate electricity are in the form of large, heavy and expensive rotating magnets and/or conductors. Because a high torque is required to rotate the generator's shaft to produce electrical energy, the energy required to mechanically rotate these heavy magnets and/or coils at a speed necessary to generate a stable electrical output is quite large and is supplied in many different ways such as, but not limited to, steam turbines, internal-combustion engines, gas combustion turbines, or water turbine. The amount of the engine's energy consumption for supplying the mechanical energy significantly exceeds the energy required to produce electrical energy.

In view of the disadvantages shown by the electric power generators of the prior art, the present inventor thought of the necessity of creating a method and a device that significantly reduces the need for large amounts of energy to mechanically generate electricity.

### SUMMARY OF THE INVENTION

It is an objective of the present invention to provide a device and method to generate an electrical potential in a low cost way.

It is another objective of the present invention to provide a device and method to generate electrical potential from a stationary magnet and a stationary conductor.

It is another objective of the present invention to provide a device and method in which a magnetic flux path is changed without a need to overpower the magnetic fields position relative to the coil.

The present invention relates to method for generating electrical potential comprising:

providing a stationary magnet, wherein the stationary magnet radiates lines of magnetic flux;

placing a stationary conductor close enough to the stationary magnet so that the lines of magnetic flux radiating from the magnet intersect the stationary conductor;

alternatively moving a magnetic shielding material between the stationary magnet and the stationary conductor to alternately shield or expose (contract or expand) the lines of magnetic flux radiating from the stationary magnet across the stationary conductor;

wherein the movement of the magnetic shielding material generates an electric potential across the stationary conductor.

The magnetic shield is made of a non-ferrous or semi-ferrous magnetic shielding material.

In addition, the present invention relates to a device for generating electrical potential comprising:

a stationary magnet, wherein the stationary magnet radiates lines of magnetic flux;

a stationary conductor located close enough to the stationary magnet to be intersected by it lines of magnetic flux;

a movable magnetic shielding material; and

means for moving the magnetic shielding material between the stationary magnet and the stationary conductor to alternately shield or expose the stationary conductor to the lines of magnetic flux radiating from the stationary magnet;

wherein the movement of the magnetic shielding material generates an electric potential across the output of the stationary conductor.

Furthermore, the present invention relates to a generator for generating electrical potential comprising:

a motor;

a drive belt in connection with the motor, wherein the motor spins the drive belts that rotates a pulley located between a stationary magnet and a stationary coil, wherein the stationary magnet generates lines of magnetic flux;

a movable magnetic shield;

means for moving the shield between the stationary magnet and the stationary conductor to alternately shield or expose the stationary conductor to the lines of magnetic flux from the stationary magnet;

wherein the movement of the magnetic shielding material generates an electric potential across the output of the stationary conductor.

Altering the physical position of a magnetic deflection and/or shielding material between a stationary magnet and a stationary conductor to generate an electrical potential is novel, non-obvious and useful. In addition, mechanically generating electrical potential without the necessity of moving the magnet physically across the conductor is new, non-obvious and useful.

Furthermore, mechanically generating electrical potential without the necessity of moving the conductor across a magnet is new, non-obvious and useful.

Finally, the process of simulating a moving magnetic field to generate an electrical potential across a conductor is new, non obvious and useful.

The device and method according to the present invention significantly reduces the need for large amounts of energy to mechanically generate electricity because the magnetic shielding and/or deflecting material used to expose or insulate (expand or contract) the lines of magnetic flux across the conductor is only a fraction of the weight of the heavy magnets and conductive materials used in the current process. Thus, the energy cost of rotating the magnetic shield is many times lower than the energy cost for rotating either the magnet and/or the conductor.

### BRIEF DESCRIPTION OF THE DRAWINGS

FIG. 1 illustrates the device with unshielded magnetic lines of flux cutting across a conductor resulting in an electrical potential across the output of the conductor.

FIG. 2 illustrates the device according to the present invention in which the magnetic flux lines are being prevented from cutting across the stationary conductor by placing a non-ferrous or semi-ferrous magnetic shielding and/or deflecting material between the stationary magnet and the stationary coil resulting in a null (Zero) electrical potential across the output of the conductor.

FIG. 3 illustrates the first side view of a generator according to the present invention showing a stationary magnet.

FIG. 4 illustrates a second side view of the generator according to FIG. 3 showing a stationary conductor.

FIG. 5 illustrates a generator according to the present invention showing a positive voltage output from the conductive coil.

FIG. 6 illustrates a generator according to the present invention showing a zero voltage output from the conductive coil.

### DESCRIPTION OF THE INVENTION

The following description is provided to enable any person skilled in the art to make and use the invention and set forth the best modes contemplated by the inventor of carrying out his invention. Various modifications, however, will remain readily apparent to those skilled in the art, since the general principles of the present invention are defined herein specifically to provide an improved device and method for generation of electrical potential.

The term “electrical generator” as used herein, means any unit that generates electrical power. Non-limiting examples of a power generator may include electromagnetic generators.

As indicated before, Faraday showed in 1832 that a current was generated in a conductor when:
1) A magnetic field moves across a conductor; or
2) A conductor moves across a magnetic field.

According to Faraday's Law of Induction, when a magnet or conductor moves relative to the other, for example when a conductor is moved across a magnetic field, a current is caused to circulate in the conductor. Furthermore, when the magnetic force increases or decreases, it produces electricity; the faster it increases or decreases, the more electricity it produces. In other words, the voltage induced in a conductor is proportional to the rate of change of the magnetic flux. In addition, based on Faraday's laws and Maxwell's equations, the faster the magnetic field changes, the larger the voltage that will be induced.

Later it was discovered that when a magnet and conductor both rotate in unison upon a magnet, a current is unexpectedly generated in the conductor. This unexpected result can be explained by assuming that the basic cause of the effect is not due to the rate of change in ‘flux’, but to the actual cutting of the conductor circuit by the lines of force.

In the above-identified circumstances, the changing of flux through a circuit will be proportional to the cutting of the conductor by the lines. Any alteration in the flux intensity, by altering the current through the coils of the conductor, must also cause a cutting of the circuit by the lines, because of the altered positioning of the lines in space.

The present invention relates to a device for generating electrical potential comprising:

a stationary magnet, wherein the stationary magnet radiates lines of magnetic flux;

a stationary conductor located close enough to the stationary magnet to be intersected by it lines of magnetic flux;

a movable magnetic shielding material; and

means for moving the magnetic shielding material between the stationary magnet and the stationary conductor to alternately shield or expose the stationary conductor to the lines of magnetic flux radiating from the stationary magnet;

wherein the movement of the magnetic shielding material generates an electric potential across the output of the stationary conductor.

Furthermore, the present invention relates to a generator for generating electrical potential comprising:

a motor;

a drive belt in connection with the motor, wherein the motor spins the drive belts that rotates a pulley located between a stationary magnet and a stationary coil, wherein the stationary magnet generates lines of magnetic flux;

a movable magnetic shield;

means for moving the shield between the stationary magnet and the stationary conductor to alternately shield or expose the stationary conductor to the lines of magnetic flux from the stationary magnet;

wherein the movement of the magnetic shielding material generates an electric potential across the output of the stationary conductor.

In creating the new configurations, the present inventor realized that a limiting aspect of most magnetic generators is the tendency of the magnetic lines of flux to leave one pole of a magnet and curve sharply around to connect with the opposite pole of that same magnet. Thus, even when the magnet is brought very close to a conductor (e.g., the coil) relatively few lines of magnetic flux actually intersect the conductor at right angles because the lines of flux loop back sharply to the opposite magnetic pole of that same magnet.

In the experiments carried out by the present inventor, the magnet and the conductor were stationary and a magnetic shield cut the lines of flux radiating from the stationary magnet; thus, there was no alteration with time in the magnetic field, or of the area concerned in the test. This fact reinforces the proposal that it is the cutting of the conductor by the magnetic lines of flux that is the critical factor. In this case, the EMF is produced through the cutting of the conductor by the magnetic lines of force radiating from the magnet. Thus, in the present invention the EMF, which is produced in a nearby conductor by a magnet, is caused by the cutting of the conductor by the magnetic lines of force of that magnet.

On the other hand, with the generators of the prior art, the EMF is caused by the cutting of the stationary circuit by the lines of force of the magnet, as the magnet rotates. It has previously been supposed that the magnet is cutting its own lines of force. As a result, the number of loops of wire in the coil must be greatly increased to get maximum generation from intersecting a relatively small number of magnetic lines of flux. One result is large and heavy coils.

The design of the device according to the present invention overcame the deficiency of the generators according to the prior art, because the use of large and heavy coils and/or the external energy required to turn the magnet and/or conductors is eliminated.

The device and process according to the present invention generates electrical energy from a stationary magnet and a stationary conductor by placing between them a non-ferrous or semi-ferrous magnetic shielding material so that as the physical position of the non-ferrous or semi-ferrous magnetic shielding material is mechanically altered to shield or expose (expand or contract) the magnetic lines of flux radiating from the stationary magnet and across the stationary conductor thereby producing an electrical potential across the output of the conductor.

When you alternately block and then expose the magnetic lines of flux to a coil by placing and removing the magnetic shielding material between them—you are effectively expanding and collapsing the magnetic lines of flux across the coil producing the electrical potential.

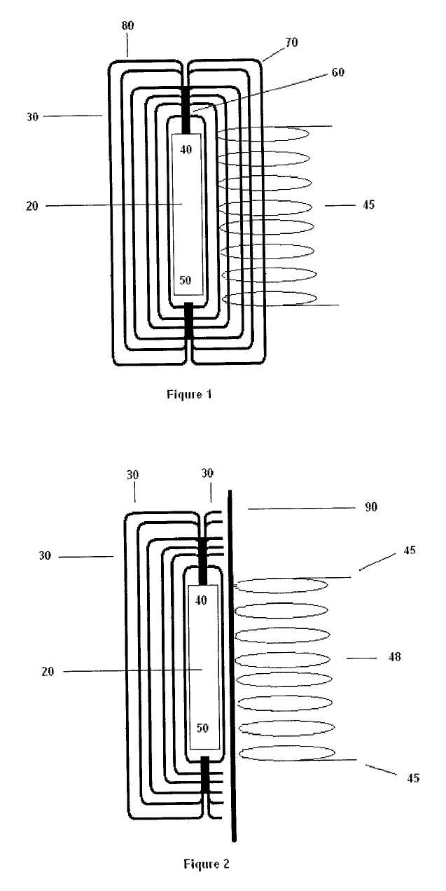

FIG. 1 shows the unshielded magnetic line of flux cutting across a conductor resulting in an electrical potential across the output of the conductor. The Figure shows a device 10 including a permanent magnet 20 to supply input lines of magnetic flux 30 moving from the North Pole 40 of the magnet 20 outward into magnetic flux path core material 60. The flux path core material 60 is configured to form a right magnetic path 70 and a left magnetic path 80, both of which extend externally between the North Pole 40 and the South Pole 50 of the magnet 20. A conductor 45 is located near the magnet 20.

### Magnets

The present invention contemplates the use of any type of magnet, preferably a permanent magnet or an electromagnet. The thickness of the magnet 20 should be chosen to be thick enough so that enough energy is produced for operation of the generator, but thin enough to keep the overall size of the generator compact and to avoid waste of magnet material.

### Strength of Magnetic Field

The magnet according to the present invention may have any shape or form. The preferred materials of the magnet are sintered and bonded Neodymium iron boron, samarium cobalt, alnico, or ceramics which are commonly used materials in the industry.

It is noted that any suitable material known in the art that has the properties of a magnet may be used in the present invention.

The dimensions of the magnet depend on the field strength of the magnet as well as the voltage and current output the generator was designed for. One example is a permanent magnet of sintered and bonded Neodymium alloy that is 0.5 to 5 inches in width, 8 to 16 inches in length, and 0.5 to 5 inches in depth. Preferably, 2 inches in width, 12 inches in length and 2 inches in depth.

### Conductor

Conductor 45 is located near the magnet 20. The conductor can be designed with a variety of objectives with respect to current and voltage generation. But basically they are either alternating or direct current conductors. The final conductor design will depend on the specific voltage and current desired and the method of storage and use of the generated electricity.

Conductor 45 preferably comprises a bundle of electrically conductive coils 48, which are placed in the path (or adjacent to the path) of the magnetic flux.

Although the Figures of the present invention show the conductor 45 having eight coils 48, the number of coils in the conductor 45 may vary depending on space requirements and based on particular applications of the electromagnetic generator 10.

In one embodiment of the present invention the wires may be covered with a liner preferably made of a non-conductive and/or non-magnetic material, such plastic or rubber or the like, to insulate the wires and to protect the wires.

### Magnetic Shield

FIG. 2 shows a drawing of the magnetic flux lines 30 being prevented from cutting across the stationary conductor by placing a non-ferrous or semi-ferrous magnetic shielding and/or deflecting material 90 between the stationary magnet 20 and the stationary conductor 45 resulting in a null (Zero) electrical potential across the output of the conductor.

The present inventor is the first one that thought of the idea of placing a movable magnetic shield between a stationary magnet and a stationary conductor in order to expand and contract the magnetic lines of flux crossing a stationary conductor to produce electromagnetic potential and generate the electricity.

The distance the stationary magnet is placed from the stationary conductive coil is determined by the physical size, shape and field strength of the magnet, the design characteristics of the coil and the electrical generators designed voltage and current output capacity. For this particular design 0.1 to 1.0 inch apart from each other, preferably 0.5 inches apart. The magnetic shield is then rotated between the stationary magnet and the stationary conductor alternately exposing and shielding (expanding and contracting) the lines of magnetic flux radiating from the stationary magnet across the conductive coil producing a voltage potential across the output of the conductive coil.

The magnetic shield 90 according to the present invention may have any shape or form, preferably circular, square or rectangular. The thickness of the magnetic shield 90 should be chosen to be thick enough to block the magnetic flux when the shield is moved between the stationary magnet and the stationary conductor, but thin enough to keep the overall size of the generator compact and to avoid waste of magnetic shielding material.

The present invention contemplates the use of any type of non-ferrous shielding material, such as the one described by Robert C. O'Handley in Modern Magnetic Materials, Principles and Applications, John Wiley & Sons, New York, pp. 456-468, which provide nanocrystalline magnetic alloys, which are particularly well-suited for rapid switching of magnetic flux. These alloys are primarily composed of crystalline grains, or crystallites, each of which has at least one dimension of a few nanometers. The entire disclosure of each of these disclosures is hereby incorporated by reference into this specification.

Other non-ferrous magnetic materials having particularly useful properties are formed from an amorphous Co—Nb—B (cobalt-niobium-boron) alloy having near-zero magnet-obstruction and relatively strong magnetization, as well as good mechanical strength and corrosion resistance.

The preferable non-ferrous material for the magnetic shield according to the present invention is the one described in U.S. Pat. No. 7,220,488, entitled “Deflecting Magnetic Field Shield” by William May and Gordon Wadle. The entire disclosure of each of these disclosures is hereby incorporated by reference into this specification. Examples 2 and 3 of the patent clearly show how a magnetic shielding material can deflect or block the magnetic lines of flux.

The main advantage to the shielding material is that it is non-ferrous; thus, there will be no loss of power from the magnet(s) when used next to the shield.

Another embodiment of the present invention contemplates the use of semi-ferrous materials for the magnetic shield.

The magnetic shield may be moved manually and/or mechanically by using any suitable device known in the art.

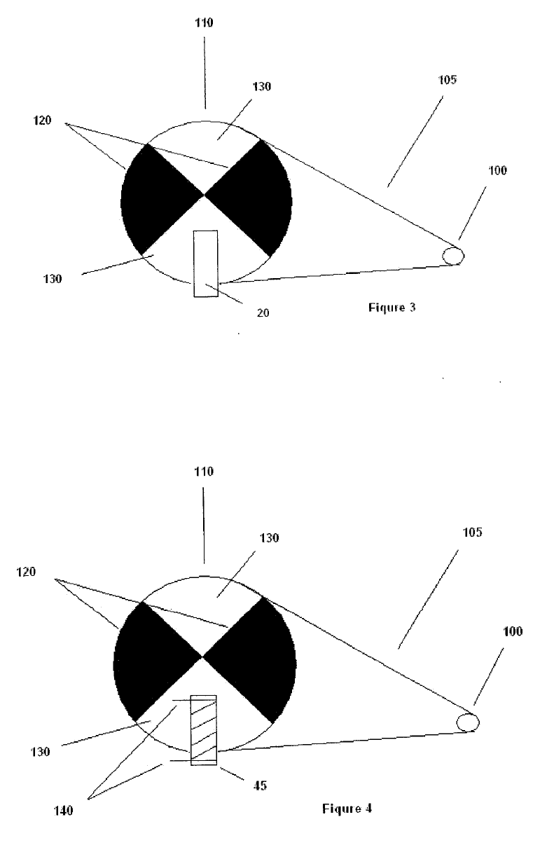

FIG. 3 illustrates the first side view of the generator according to the present invention showing a stationary magnet. FIG. 4 illustrates a second side view of the generator according to FIG. 3 showing a stationary conductor. As the motor 100 spins, the drive belt 105 rotates a plastic pulley 110 between the stationary magnet 20 and the stationary coil 45. The black areas on the pulley 120 represent the sections that have had magnetic reflection/deflection material applied to them. The white areas on the pulley 130 are magnetically transparent so as to allow the lines of magnetic flux to pass through to the coil unhindered. When the area of the pulley that has had a magnetic reflection/deflection/shielding material applied to it passes between the stationary magnet and the stationary coil and interrupts the magnetic field cutting across the conductive coil. This expanding and contracting of the magnetic field across the stationary conductor induces a voltage 140 across its output.

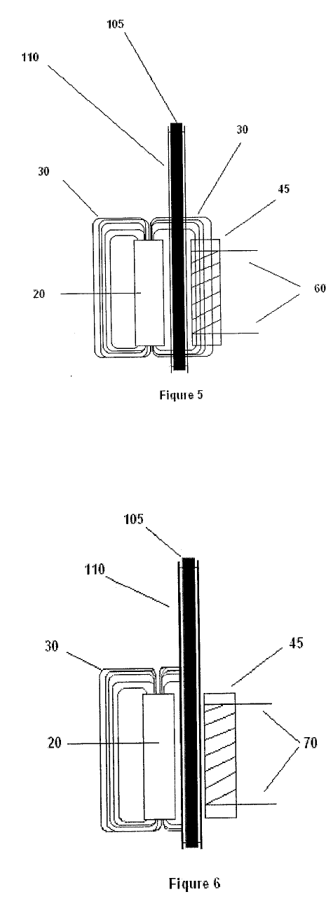

FIG. 5 illustrates a generator according to the present invention showing a positive voltage output 160 from the conductive coil. The magnetic lines of the flux 30 cut across the stationary conductor 45 as the magnetically transparent section of the pulley 110 rotates between the stationary magnet 20 and the stationary conductor 45.

FIG. 6 illustrates a generator according to the present invention showing a zero voltage output 170 from the conductive coil. The magnetic lines of the flux 30 are shielded from the conductive coil as the shielding material on the pulley rotates between the stationary magnet 20 and the stationary conductor 45. The magnetic lines of flux are blocked by the rotating shielding material; thus, there are no lines of flux.

The present invention further contemplates a method for generating electrical potential comprising:

providing a stationary magnet, wherein the stationary magnet radiates lines of magnetic flux;

placing a stationary conductor close enough to the stationary magnet so that the lines of magnetic flux radiate from the magnet intersect the stationary conductor;

alternatively moving a magnetic shielding material between the stationary magnet and the stationary conductor to alternately shield or expose (contract or expand) the lines of magnetic flux radiating from the stationary magnet across the stationary conductor;

wherein the movement of the magnetic shielding material generates an electric potential across the stationary conductor.

While several forms of the invention have been shown and described, other forms will now be apparent to those skilled in the art. Therefore, it will be understood that the embodiments shown in the drawings and described above are merely for illustrative purposes, and are not intended to limit the scope of the invention, which is defined by the claims, which follow as interpreted under the principles of patent law including the doctrine of equivalents.

What is claimed is:

1. A method for generating electrical potential comprising:
providing a stationary magnet, wherein the stationary magnet radiates lines of magnetic flux;
placing a stationary conductor close enough to the stationary magnet so that the lines of magnetic flux radiate from the magnet intersect the stationary conductor;
alternatively moving a magnetic shielding material between the stationary magnet and the stationary conductor to alternately shield or expose (contract or expand) the lines of magnetic flux radiating from the stationary magnet across the stationary conductor;
wherein the movement of the magnetic shielding material generates an electric potential across the stationary conductor.

2. The method of claim 1 wherein the magnetic shield is manually moved.

3. The method of claim 1 wherein the magnetic shield is mechanically moved.

4. The method of claim 1 wherein the magnetic shield is made of a non-ferrous or semi-ferrous magnetic shielding material.

5. A device for generating electrical potential comprising:
a stationary magnet, wherein the stationary magnet radiates lines of magnetic flux;
a stationary conductor located close enough to the stationary magnet to be intersected by it lines of magnetic flux;
a movable magnetic shielding material; and
means for moving the magnetic shielding material between the stationary magnet and the stationary conductor to alternately shield or expose the stationary conductor to the lines of magnetic flux radiating from the stationary magnet;
wherein the movement of the magnetic shielding material generates an electric potential across the output of the stationary conductor.

6. The device according to claim 5 wherein the stationary magnet is an electromagnet or a permanent magnet.

7. A generator for generating electrical potential comprising:
a motor;
a drive belt in connection with the motor, wherein the motor spins the drive belts that rotates a pulley located between a stationary magnet and a stationary coil, wherein the stationary magnet generates lines of magnetic flux;
a movable magnetic shield;
means for moving the shield between the stationary magnet and the stationary conductor to alternately shield or expose the stationary conductor to the lines of magnetic flux from the stationary magnet;
wherein the movement of the magnetic shielding material generates an electric potential across the output of the stationary conductor.
